(19) United States
(12) Patent Application Publication
(10) Pub. No.: US 2022/0367163 A1
(43) Pub. Date: Nov. 17, 2022

(54) PARALLEL MULTI-BEAM TIME-OF-FLIGHT MASS SPECTROMETER

(71) Applicant: The Rockefeller University, New York, NY (US)

(72) Inventors: Andrew Krutchinsky, New York, NY (US); Brian Chait, New York, NY (US)

(21) Appl. No.: 17/752,099

(22) Filed: May 24, 2022

Related U.S. Application Data
(62) Division of application No. 15/734,808, filed on Dec. 3, 2020, now abandoned.
(60) Provisional application No. 62/680,679, filed on Jun. 5, 2018.

(51) Int. Cl. H01J 49/00; H01J 49/40; H01J 49/42

(52) U.S. Cl. CPC H01J 49/009; H01J 49/40; H01J 49/4225

(57) ABSTRACT

A parallel multi-beam mass spectrometer includes an ion trap and a single multi-beam time-of-flight analyzer. The trap has a plurality of alternating electrodes configured to form a plurality of quadrupoles defining a surface of the trap, wherein at least two of the plurality of quadrupoles are configured as mass filters for selective ejection of concurrent parallel beams of ions from the trap in respective predetermined ion mass-to-charge windows. The single multi-beam time-of-flight analyzer has a position sensitive detector or a plurality of individual detectors for simultaneously receiving and analyzing the concurrent parallel beams of ions.

### CROSS-REFERENCE TO RELATED APPLICATIONS

This application is a divisional application of U.S. application Ser. No. 15/734,808, filed Dec. 3, 2020, which is a national stage application of PCT/EP2019/035561 filed Jun. 5, 2019, which claims priority from U.S. provisional application Ser. No. 62/680,679, filed on Jun. 5, 2018, the specification of which is incorporated herein in its entirety for all purposes.

### GOVERNMENTAL SUPPORT

The research leading to the present invention was supported, at least in part, by NIH Grant No. PHS GM103314. Accordingly, the United States Government may have certain rights in the invention.

### TECHNICAL FIELD

The present disclosure relates to mass spectrometry and, in particular, to a system that will enable massively parallel mass selective ion ejection.

### BACKGROUND

Ion trap mass spectrometers have conventionally operated with a three-dimensional (3D) quadrupole field formed, for example, using a ring electrode and two end caps. In this configuration, the minimum of the potential energy well created by the radio-frequency (RF) field distribution is positioned in the center of the ring. Because the kinetic energy of ions injected into an ion trap decreases in collisions with buffer gas molecules, usually helium, the injected ions naturally localize at the minimum of the potential well. As has been shown using laser tomography imaging, the ions in these conventionally constructed ion traps congregate in a substantially spherical distribution, which is typically smaller than about 1 millimeter in diameter. The result is a degradation of performance of the device when attempting to trap large numbers of ions, due to space charge effects.

As one possible solution to this problem, quadrupole mass spectrometers having a two-dimensional quadrupole electric field were introduced in order to expand the ion storage area from a small sphere into an extended cylindrical column. An example of this type of spectrometer is provided in U.S. Pat. No. 5,420,425 to Bier, et al. The Bier, et al. patent discloses a substantially quadrupole ion trap mass spectrometer with an enlarged or elongated ion occupied volume. The ion trap has a space charge limit that is proportional to the length of the device. After collision relaxation, ions occupy an extended region coinciding with the axis of the device. The Bier, et al. patent discloses a two-dimensional ion trap, which can be straight, or of a circular or curved shape, and also an ellipsoidal three-dimensional ion trap with increased ion trapping capacity. Ions are mass-selectively ejected from the ion trap through an elongated aperture corresponding to the elongated storage area.

Though increased ion storage volume is provided by the ion trap geometry of the Bier, et al. patent, the efficiency and versatility of the mass spectrometer suffer, for example, due to the elongated slit and subsequent focusing of the ions required after ejection. In addition, the storage volume is limited by practical considerations, since the length of the spectrometer must be increased in order to increase the ion storage volume.

Various types of mass analyzers for acquiring the ions ejected from such traps are known in the art. Time-of-flight (TOF) instruments acquire spectra at very high frequency. However, one limiting factor of such TOF instruments is that they must be operated in tandem with sequential instruments, such as ion traps or quadrupoles, which are frequently used for selecting the precursor ions. While selecting the species of interest for MS/MS analysis, usually other species present in the ion beam generated from a given sample are rejected, and, thus, they are lost for the analysis. This decreases the total efficiency of analysis with this type of instrument.

Thus, most mass spectrometric (MS) analyses are performed in sequential mode, wherein various species in a sample are selected and interrogated one after another. As a consequence of the finite time needed to examine each species in turn, sequential mode MS suffers from inescapable limitations in sensitivity, speed and ability to analyze all ions, especially when the composition of the ion beam is complex and rapidly changing. These limitations have kept vast tracts of biology and biomedicine, including, for example, deep single cell proteome analysis, out of reach of the current MS technology.

One solution that has been proposed is to split the ion current into N independent m/z channels. This solution is described in commonly owned U.S. Pat. No. 8,637,817 to Krutchinsky et al. The Krutchinsky et al. patent discloses an efficient and versatile ion trap for use in a mass spectrometer, which provides both good ion storage volume and efficient ejection of selected ions, as well as splitting the incoming ions beam into sub-beams containing ions from non-overlapping m/z regions. Simultaneous analysis of ions in these parallel beams results in improved sensitivity, speed and dynamic range, thus overcoming the technical barriers inherent to current commercial mass spectrometers that operate largely in sequential mode.

The present disclosure sets forth improvements on the invention disclosed in the Krutchinsky et al. patent to provide a versatile and efficient system and instrumentation device for parallel mass-to-charge filtering in mass spectrometry.

### SUMMARY

The disclosure is directed to a multi-beam time-of-flight mass spectrometer system including a high-capacity and versatile ion trap device that transmits ions through a multiplicity of trap outputs according to their m/z values, (i.e., splitting the stream of incoming ions, in real time and without loss, into concurrent sub-beams containing ions with specified and non-overlapping m/z values). Realization of this mode of operation will allow ions from these concurrent beams to be further analyzed in parallel by a position sensitive detector, or an array of mass spectrometers, (e.g. ion traps), or a single multi-beam time-of-flight analyzer with a position sensitive detector.

In one aspect of the present invention a parallel multi-beam mass spectrometer is provided. The parallel multi-beam mass spectrometer includes an ion trap and a single multi-beam time-of-flight analyzer. The trap has a plurality of alternating electrodes configured to form a plurality of quadrupoles defining a surface of the trap, wherein at least two of the plurality of quadrupoles are configured as mass filters for selective ejection of concurrent parallel beams of ions from the trap in respective predetermined ion mass-to-charge windows. The single multi-beam time-of-flight analyzer has a position sensitive detector for simultaneously receiving and analyzing the concurrent parallel beams of ions or a multiplicity of detectors, each one receiving and detecting a single ion beam.

The parallel multi-beam mass spectrometer further preferably includes a plurality of collision cells, each collision cell communicating with one of the at least two of the plurality of quadrupoles configured as mass filters, wherein the collision cells fragment concurrent parallel beams of ions.

The single multi-beam time-of-flight analyzer further preferably includes a time-of-flight accelerator column for pulsing the concurrent parallel beams of ions into respective time of flight paths. The single multi-beam time-of-flight analyzer further preferably includes a time-of-flight mirror for orthogonal reflection of the concurrent parallel beams of ions.

In one aspect of the invention, the plurality of quadrupoles configured as mass filters include a first quadrupole and a second quadrupole, wherein the first quadrupole is defined by four alternating electrodes configured for application of respective opposite polarities of a first RF signal, and the second quadrupole is defined by four alternating electrodes configured for application of respective opposite polarities of a second RF signal. As a result, the first quadrupole transmits ions with a first range of mass to charge values and the second quadrupole transmits ions with a second range of mass-to-charge values different than the first range.

It is possible for the first and second quadrupoles to share two electrodes whereby the first and second quadrupoles spatially overlap. In this embodiment, the two shared electrodes are segmented to permit application of two different RF signals to the same two shared electrodes.

In one aspect of the present invention, the amplitudes of the RF and DC components of the first and second RF signals are adjusted to attract and transmit different respective mass-to-charge ranges of ions. The first and second RF signals can be formed by square pulses or the first and second RF signals can take a broadband excitation waveform designed to excite ions in all mass-to-charge ranges except those that are to be transmitted through the respective first and second quadrupoles.

In another aspect of the present invention, a method for parallel multi-beam mass spectrometry is provided. The method generally includes grouping alternating electrodes defining a surface of an ion trap into a plurality of quadrupoles, configuring at least two of the plurality of quadrupoles as respective mass filters for selective ejection of concurrent parallel beams of ions from the trap in predetermined ion mass-to-charge windows, transmitting the concurrent parallel beams of ions to a single multi-beam time of flight analyzer and simultaneously analyzing the concurrent parallel beams of ions with a position sensitive detector.

In a preferred embodiment, the method further includes fragmenting the concurrent parallel beams of ions with at least one collision cell disposed between the ion trap and the time-of-flight analyzer. The method further preferably includes pulsing the concurrent parallel beams of ions into respective time of flight paths with the time-of-flight analyzer and orthogonally reflecting the concurrent parallel beams of ions with a time-of-flight mirror of the time-of-flight analyzer.

In one aspect of the invention, the step of configuring at least two of the plurality of quadrupoles as respective mass filters includes applying respective opposite polarities of a first RF signal to alternating electrodes of a first quadrupole of the at least two of the plurality of quadrupoles and applying respective opposite polarities or a second RF signal to alternating electrodes of a second quadrupole of the at least two of the plurality of quadrupoles, the second RF signal being different than the first RF signal, wherein the first quadrupole transmits ions with a first range of mass-to-charge values and the second quadrupole transmits ions with a second mass-to-charge values different than the first range.

The first and second quadrupoles may share two electrodes whereby both the first RF signal and the second RF signal are applied to the two shared electrodes. In this case, the two shared electrodes are segmented to permit application of both the first RF signal and the second RF signal.

Features of the disclosure will become apparent from the following detailed description considered in conjunction with the accompanying drawings. It is to be understood, however, that the drawings are designed as an illustration only and not as a definition of the limits of this disclosure.

### BRIEF DESCRIPTION OF DRAWINGS

FIG. 1 is a schematic representation of a perspective view of an embodiment of an ion trap device of the prior art.

FIG. 2 is a schematic representation of a cross-sectional view of an embodiment of a mass spectrometer including an ion trap device of the prior art.

FIG. 3 is schematic representation of an ion trap configured to produce m/z selective exits according to an aspect of the present invention.

FIG. 3A is an enlarged isolated view of a section of the ion trap shown in FIG. 3 showing electrode connections according to one aspect of the present invention.

FIG. 3B is an enlarged isolated view of a section of the ion trap shown in FIG. 3 showing electrode connections according to another aspect of the present invention.

FIG. 4 shows the type of sinusoidal electrical signals that are used to drive the quadrupoles as mass filters according to the present invention.

FIG. 5 is a schematic diagram of an elongated ion trap device with ten parallel outputs feeding a single position sensitive detector according to the present invention.

FIG. 6 is a schematic diagram of an elongated ion trap device with ten parallel outputs feeding ten orbitraps according to the present invention.

FIG. 7 is a schematic diagram of an elongated ion trap device with ten parallel outputs feeding a time-of-flight mass spectrometer capable of analyzing ten concurrent ion beams at the same time according to the present invention.

### DETAILED DESCRIPTION OF EMBODIMENTS

The following sections describe embodiments of the present disclosure. It should be apparent to those skilled in the art that the described embodiments with accompanying figures provided herein are illustrative only of the invention and not limiting, having been presented by way of example only.

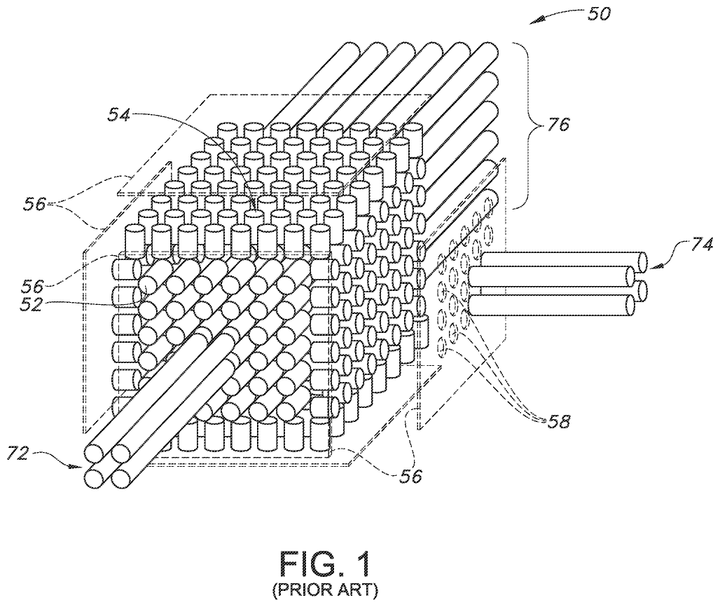

A multi-quadrupole ion trap (MultiQ-IT) device of the prior art is disclosed in U.S. Pat. No. 8,637,817, the specification of which is incorporated herein by reference in its entirety for all purposes. As disclosed in U.S. Pat. No. 8,637,817, and shown in FIG. 1, the multi-pole ion trap includes a plurality of electrodes positioned around an ion confinement region, preferably in a regular pattern. The plurality of electrodes is preferably confined to the surface area, or faces, of a regular polyhedron and is positioned on at least the vertices of the regular polyhedral structure. In various preferred embodiments, the plurality of electrodes also includes additional electrodes arranged along the edges and between the edges in a regular pattern on the surfaces or faces of the polyhedron. By appropriate application of RF voltages, where neighboring electrodes are maintained at any point in time at opposing polarities or phases, these arrangements of electrodes on a polyhedral structure provide surfaces with a high electric potential, which will repel and contain ions within an ion containment region bounded by the polyhedral structure. Accordingly, the containment volume for storage of ions corresponds substantially to the volume encompassed by the surface area of the polyhedron.

For example, an ion trap in the form of a cube of dimensions 10 cm×10 cm×10 cm, an example of which is provided in FIG. 1, can store over 10¹⁰ ions, and is limited in principle only by dimensions of the ion trap. The ion trap device 50 can take the form of a regular polyhedral structure in the form of a cube which encloses an ion containment region 54. A plurality of electrodes 52, which are in the shape of cylindrical rods, are positioned on a surface area of the cube in a regular pattern, the cylindrical electrodes 52 being positioned at the eight vertices of the cube and also between the vertices in each dimension such that there are N×N electrodes positioned on each surface. In the example shown in FIG. 1, the number of electrodes N equals 8.

The electrodes of the ion trap device are confined to the surfaces of the cube in FIG. 1, providing a large hollow interior 54 for containing ions. In various additional embodiments of an ion trap device in the shape of a cube, a total number of electrodes encompassing the ion containment region can be calculated as N³−(N−2)³ electrodes, where N is any integer number that is larger or equal to 2. In addition, preferably, the ends of the cylindrical electrodes in the embodiment of FIG. 1 are appropriately arranged and oriented to create a total of N³−(N−2)³−2 quadrupoles, from four closest neighbor electrode sets, on the surfaces of the cube. Accordingly, the ion trap of FIG. 1, where N equals 8, is formed from 296 electrodes, from which 294 quadrupoles can be formed.

Quadrupoles are commonly known for use as ion guides and/or mass filters. Each pair of adjacent rods in a quadrupole is connected to a positive or a negative RF potential of suitable magnitude and frequency for the particular application, so that direct neighbors are maintained at opposing polarities or phases with the same amplitude. This arrangement is known to provide radial confinement of ions around a central axis of the rod set forming the quadrupole.

In ion traps, this same pattern of alternating RF signals is applied to adjacent electrodes formed on each surface of a regular polyhedral structure enclosing an ion containment region. In the case of the cube-shaped ion trap 50, for example, a total of 294 quadrupoles are formed, which surround the ion containment region 54. By appropriate application of alternating RF phases, a steep potential barrier can be formed at the surfaces of the cube with a shallow well towards the center of the device that will effectively repel positive and negative ions towards the center of the device and trap ions inside the volume 54. In this way, a very large number of ions with a wide range of masses can be trapped in the device.

The ion trap device of the prior art can also include plate electrodes 56 outside the surfaces 70 of the regular polyhedral structure of the device. To prevent ions from escaping the ion containment region along the axis of quadrupoles, where the RF field is small, a small DC potential can be applied to any number of the plate electrodes to repel the ions back towards the containment region 60. In various embodiments, a DC voltage is applied in the range of between about 0 V and about +1000 V, preferably in the range of between about +0.02 V to about +100 V to at least a portion of the plate electrodes to prevent, for example, positive ions from escaping.

Any of the plate electrodes 56 can include ports 58 to allow ions to be injected into the ion containment region 54, and/or for ejecting ions out of the ion containment region 54. To guide ions into the containment region 54, the two-dimensional array of rod-shaped electrodes on one of the surfaces of the cube can include a quadrupole ion guide 72 to guide ions into a containment volume and/or a quadrupole ion guide 74 to guide ions out of the containment volume.

By applying an RF voltage with a characteristic frequency corresponding to a particular ion mass range to the electrodes forming the surface of the ion trap cube, mass selective ion ejection can be achieved along the axes of the quadrupoles arranged on the containment surfaces. Similarly, the voltage and frequency of the RF signal applied to the rods of the quadrupole ion guides 72, 74 can be appropriately adjusted for ion guiding and/or for mass filtering for a particular mass-to-charge window. Accordingly, ions can be ejected in a mass-to-charge dependent manner through a port 58 in a plate electrode 56, for example, appropriately positioned to coincide with the region centered along the axis of the quadrupole 74.

The ion device can include a large number of quadrupoles. As shown in FIG. 1, an extended rod set of quadrupoles 76 can be provided and used for parallel analysis of the mass-to-charge values of a large range of ions stored in the trap. By appropriate application of different characteristic frequencies corresponding to different mass-to-charge windows, mass selective ion ejection from the device can be performed periodically or continuously along any or all of the N³−(N−2)³−2 quadrupole axes.

Accordingly, a parallel mass spectrometer can include up to N³−(N−2)³−2 individual mass analyzers, one for each mass-to-charge window of ions ejected from each quadrupole for simultaneous parallel analysis of the ions stored in the device. Highly efficient parallel mass spectrometry free of losses associated with conventional sequential ion scanning can therefore be provided by implementing the ion device disclosed in U.S. Pat. No. 8,637,817.

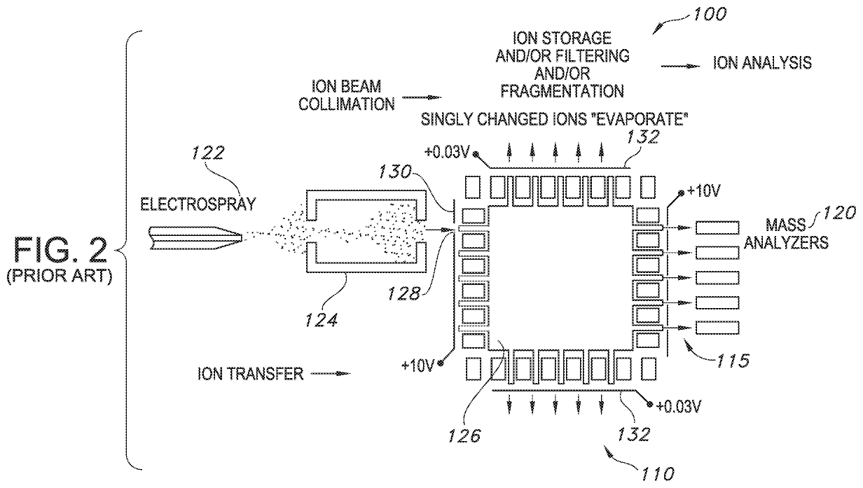

Referring to FIG. 2, a parallel mass spectrometer 100 includes an embodiment of an ion trap 110 in accordance with the disclosure of U.S. Pat. No. 8,637,817, with multiple parallel outputs 115 of ions in multiple m/z windows. The mass spectrometer can include a plurality of mass analyzers 120 for parallel mass analysis, with each mass analyzer coupled to a different output port 115. The ion trap 110, which in this particular embodiment includes 296 cylindrical rod electrodes, can be coupled to any appropriate ion source 122, such as an electrospray ionization source (ESI), or an appropriate Matrix-Assisted Laser Desorption-Ionization (MALDI) source. The mass spectrometer 100 can also include other elements known in the art such as a collimation device 124 for coupling ions from the ion source 122 into the ion trap 110. In other embodiments, additional input ports can be provided to couple to additional ion or other sources.

The plate electrode 130 is preferably biased with a high DC voltage (e.g., about +10V) for containment of the injected ions in the containment region 126. Additional plates 132 can be biased at a small DC voltage, e.g., about +0.03V, for depletion of singly-charged ions. As discussed herein below, depletion of these singly-charged ions provides a mass spectrometer characterized by a high signal-to-noise ratio.

Mass selective ion ejection from embodiments of the ion trap device with multiple mass filtered outputs, such as the device 110, can be performed periodically or continuously along any or all of the N³−(N−2)³−2 quadrupole axes. The mass selective ion ejection, or filtering, can be performed according to methods known in the art, such as by mass resonance ion ejection, or using resonance ion injection into each quadrupole axis (channel) by supplying wide band resonance excitation containing all frequencies that excite all ions in the trap except the ions characterized by a particular m/z. These ions pass through the quadrupole to be detected at the exit using multiple ion detectors, or using a large array detector, or in the case of analysis of chemical and biological assays, a “soft-landed” species device.

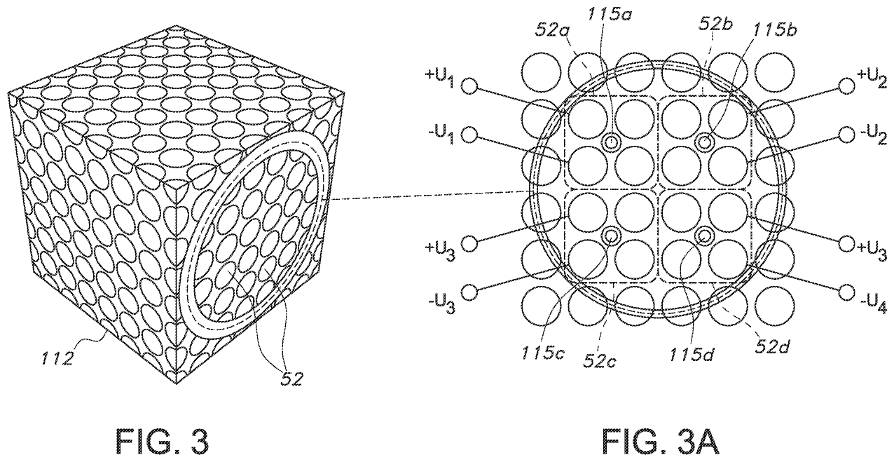

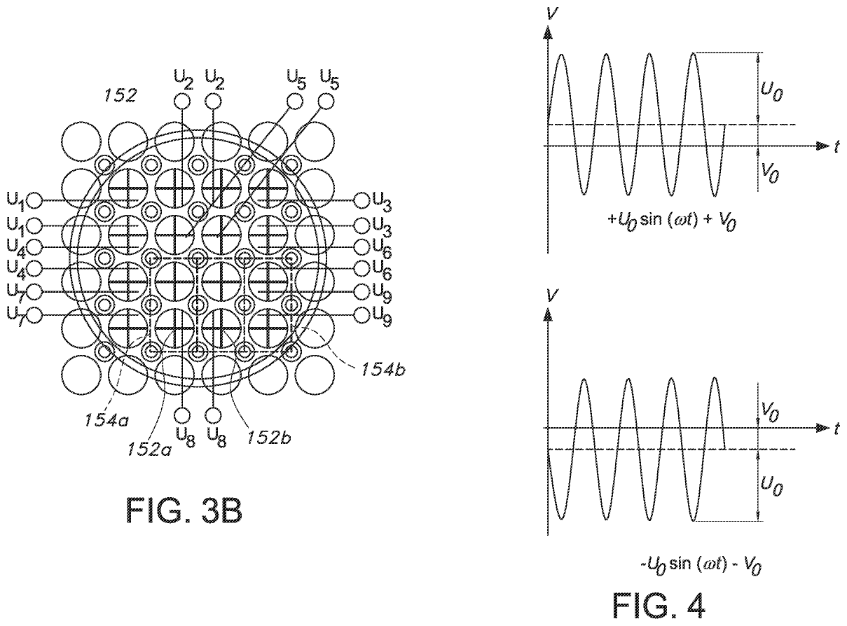

In one or more embodiments of the present invention, one specific method for selectively ejecting ions from an ion trap 112, as disclosed in U.S. Pat. No. 8,637,817, is schematically shown in FIGS. 3 and 3A. In this aspect, the electrodes 52 can be controlled either as a group or individually, allowing ions to leave the device 112 according to either the value of their m/z ratio or charge z. The first feature (m/z-control) enables real-time splitting of the initial ion beam into as many as N concurrent sub-beams containing ions from non-overlapping m/z ranges, to allow their analysis in parallel. The second feature (z-control) can be extremely useful for improving the signal-to-noise (S/N) ratio in ESI-MS, especially when analyzing minuscule amounts of sample.

Specifically, FIGS. 3 and 3A show a scheme for connecting the quadrupole electrodes 52 of the ion trap 112 to produce m/z selective exits of ions. The selected electrodes 52 on one surface of the trap 112 can be grouped into individual quadrupoles 52a, 52b, 52c, 52d, wherein each the electrodes of an individual quadrupole is driven as an individual selective mass filters. For example, the electrodes of a first individual quadrupole 52a can be driven by opposite polarity electrical signals having a first RF amplitude U₁ so as to transmit ions with a range of specific m/z values along a first quadrupole axis 115a, while the electrodes of a second individual quadrupole 52b, immediately adjacent the first group 52a, can be driven by opposite polarity electrical signals having a second RF amplitude U₂ so as to transmit ions with a second range of specific m/z values, different than the first range, along a second quadrupole axis 115b.

Ions that cannot make it through a given quadrupole 52a, 52b, 52c, 52d that is set to transmit a given range of m/z values ions will be repelled back into the trap 112 by the quadrupole fringing fields. These repelled ions will further explore the trap from the inside until they find the exit 115a, 115b, 115c, 115d that is specifically designed to transmit them. It has been found that ion trajectories become destabilized as they approach a given quadrupole along the quadrupole axes under conditions that prohibit their exit, providing a mechanism for ion containment within the trap 112.

FIG. 3A shows an embodiment with a grouping of electrodes into quadrupoles, without overlapping use of neighboring electrodes and electrical connections. FIG. 3B shows an embodiment, wherein the electrodes 152 are segmented for overlapping use of neighboring electrodes. By segmenting the electrodes 152 into quarters and applying matching RF amplitudes U₁-U₉ to opposing quarters of the electrodes in each group of four electrodes, electrodes 152a, 152b of immediately adjacent quadrupoles 154a, 154b can be shared so that overlapping quadrupoles can be formed. In one aspect, cylindrical electrodes are physically divided into axial quarters, wherein insulating plates may be disposed between the quarters to electrically isolate the quarters. The quarters can then be individual connected to an electric source to be separately driven.

FIG. 4 shows the type of sinusoidal electrical signals that are used to drive the quadrupoles 52, 152 as mass filters. In this case, the amplitudes of the RF (Uo) and DC (Vo) components are set according to experimental calibration data so as to transmit ions with specific m/z values. The different quadrupoles are driven with Uo and Vo adjusted to attract and transmit the desired m/z range of ions through the respective exit 115a, 115b, 115c, 115d formed by the quadrupoles.

It is also possible to use RF signals formed by square pulses (not shown), wherein the duration of the positive and negative part of the pulses can be adjusted so as to keep the duty cycle between 0.38 and 0.5, for example. When the duty cycle is set to 0.5, the quadrupole operates in the RF-only mode transmitting a wide range of ions. However, when the duty cycle is set close to 0.38 the quadrupole will transmit a narrow range of ions (˜1 Th), centered on a m/z value determined only by the amplitude of the RF signal. These features provide a convenient “digital” way to control multiple mass filters of the ion trap because the filtered value of m/z depends on the amplitude of the RF signal (at a given RF frequency), while the duty cycle sets the width of the transmission window.

Another possible mode of operation involves mixing into the major RF signal a specially designed broadband excitation waveform designed to excite all ions in the observable m/z range except those that are to be transmitted through a given quadrupole exit. This specially designed waveform can be provided by subtracting a specific frequency from a “white noise” spectrum of frequencies, wherein the specific frequency subtracted from the spectrum is characteristic for the ions to be transmitted through a given quadrupole exit.

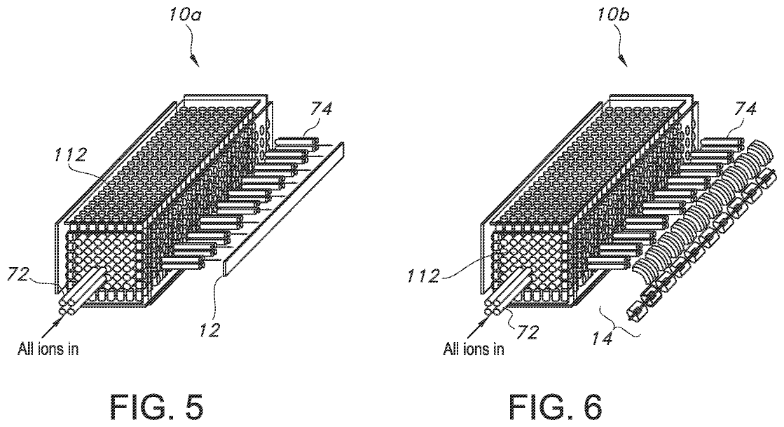

Turning now to FIGS. 5-7, various embodiments 10a, 10b 10c of a parallel multi-beam mass spectrometer according to the present invention are shown. The mass spectrometry systems of the present disclosure preferably includes an embodiment of the ion trap 112, as described above. An ion trap 110, as disclosed in U.S. Pat. No. 8,637,817, can also be utilized. In either case, the multiple quadrupoles of the ion trap 112, 110 are used as mass filters, as described above, wherein quadrupoles are arranged and controlled for providing a different m/z window for conditioning the ion beam for analysis. Accordingly, a parallel mass spectrometer is provided which includes an ion trap device of the present disclosure for performing parallel analysis of all ions in the enclosure.

The ion traps 112 shown in FIGS. 5-7 are configured in an elongated embodiment (elongated cube), wherein an ion guide 72 is provided at the shorter surface of the trap for injection of ions into the trap in a conventional manner. The elongated design of the trap 112 enables, for example, ten (10) non-overlapping quadrupoles arranged in a manner described above with respect to FIG. 3A. However, it is conceivable that the ion trap 112 can be configured with overlapping quadrupoles, as shown in FIG. 3B. In either case, each quadrupole is assigned a respective ion guide 74 for guiding ions along respective paths out of the trap.

It is further conceivable that more than one ion trap 112 can be connected in series to increase the signal-to-noise ratio by a factor of XN, where X is the signal-to-noise improvement of a single ion trap and N is the number of ion traps in series. In this embodiment, the ions are subjected to a 2^{nd} 3^{rd}, . . . N^{th} round of ion selection and fragmentation prior to mass analysis.

Such embodiment can yield a wealth of information, including the identity of macromolecular species involved in specific biological processes, the identity and location of chemical modifications and processing events on macromolecules, the interaction of specific macromolecules, single cell proteome analysis, chemical crosslinking data that are valuable for structural modeling of macromolecular complexes, the stoichiometry of macromolecular complexes, as well as quantitative aspects of many cellular processes.

In FIG. 5, an elongated ion trap device 112 with ten parallel outputs provides parallel beams of ions to a single position sensitive detector 12.

In FIG. 6, an elongated ion trap device 112 with ten parallel outputs directs ions to an array of ten individual orbitraps 14 for simultaneously analyzing ions from different m/z ranges.

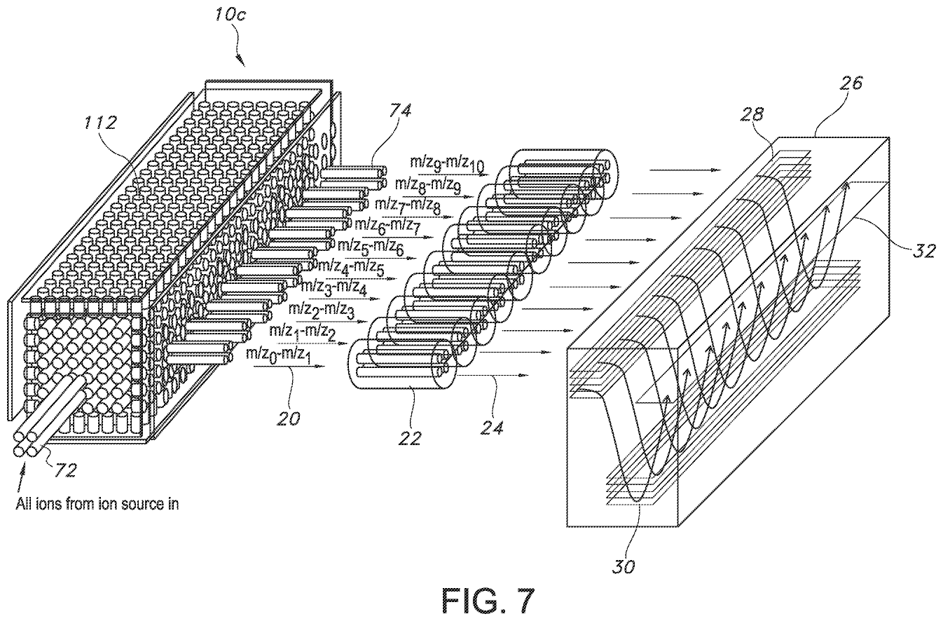

In FIG. 7, an elongated ion trap device 112 with ten parallel outputs directs ten parallel beams to a time-of-flight mass spectrometer 26 capable of analyzing ten concurrent ion beams at the same time. In this embodiment, a multi-beam time-of-flight mass spectrometer is provided, which includes a high-capacity and versatile ion trap device that transmits ions through a multiplicity of trap outputs according to their m/z values, (i.e., splitting the stream of incoming ions, in real time and with minimal loss, into concurrent sub-beams containing ions with specified and non-overlapping m/z values).

As described above, the voltage and frequency of the RF signal applied to the electrodes of a plurality of quadrupoles arranged on the trap 112 can be individually and appropriately adjusted so that each ion guide 74 can guide ions out of the trap 112 based on a particular mass-to-charge window. Thus, ions from an ion source (not shown) are split in real time in concurrent sub-beams 20 containing ions in ten non-overlapping m/z regions.

These beams 20 are preferably directed to respective collision cells 22, where they can be fragmented to create ten concurrent fragmentation channels 24. FIG. 7 shows individual collision cells respectively assigned to each beam 20. However, it is conceivable to provide a single collision cell for multiple beam fragmentation. In either case, the collision cells 22 can transmit incoming ions either without inducing their fragmentation or with fragmentation. Ions leaving the collision cell will then either correspond to the incoming ions or their fragments, which provide information on the structure of the incoming ions. Such collision cells that can induce collision-induced fragmentation are widely used in modern mass spectrometric instrumentation.

The resulting fragment channels 24 from each collision cell 22 are simultaneously sent to a single time-of-flight analyzer 26, which simultaneously analyzes the fragment ions in different m/z ranges. The single time-of-flight analyzer 26 preferably includes a time-of-flight accelerator column 28, (which pulses and accelerates ions into the time of flight path), a time-of-flight mirror 30 and a position sensitive detector 32. FIG. 7 shows a time-of-flight analyzer 26 with a single position sensitive detector 32. However, in another possible embodiment of the present invention, the time-of-flight analyzer 26 may include an individual detector for each ion beam.

All ions entering the time-of-flight analyzer 26 are pulsed toward the single position sensitive detector 32, or the multiple individual detectors. Their times-of-flight are measured from the instant of the applied pulse to the instants when they reach the detector. However, ions in the multiple parallel beams (either intact or fragments) need to be discerned from each other. This can be done using a separate detector for each concurrent beam. An alternative solution, according to the present invention, uses a “single” detector 32 that can recognize the position at which the ions from each beam strike (i.e., a detector that can detect both the arrival times of the ions and their positions). In a preferred embodiment, the concurrent beams should have clearly discernable positions on this position sensitive detector.

The time-of flight-analyzer 26 can be a conventional linear TOF analyzer, or a TOF analyzer with a mirror, commonly used in modern TOF mass analyzers to increase the resolution of such analyzers. In a preferred embodiment, an orthogonal injection TOF analyzer that accepts ions in an orthogonal direction to the TOF path is used. This is the most appropriate type of TOF analyzer for the present multibeam purpose, where each beam is continuous in time.

The term “time-of-flight” is used to describe a type of analyzer that measures the time that ions take to travel through a given time-of-flight. It is straightforward and common practice to deduce the m/z (mass to charge ratio) of ions from their measured times-of-flight (usually using known calibrants). As described above, in the style of TOF analyzer shown in FIG. 7, ions can be pulsed toward multiple individual detectors or a single position sensitive detector. Their times-of-flight are measured from the instant of this pulse and the instants that the reach the detector.

Thus, the ions in the channels 24 are analyzed in parallel in a single orthogonal reflection time-of-flight mass spectrometer, which separates ions into ten ion beams at the same time and detects the separated ions either in a position sensitive detector or in 10 separate detectors.

It should be apparent to those skilled in the art that the described embodiments of the present invention provided herein are illustrative only and not limiting, having been presented by way of example only. As described herein, all features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto.

1-22. (canceled)

23. A parallel multi-beam mass spectrometer comprising:
an ion trap having a plurality of electrodes configured to form a plurality of quadrupoles defining a surface of the trap, wherein at least two of the plurality of quadrupoles are configured as mass filters for selective ejection of concurrent parallel beams of ions from the trap in respective predetermined ion mass-to-charge windows; and
a single multi-beam time-of-flight analyzer for simultaneously receiving and analyzing the concurrent parallel beams of ions,
wherein the at least two of the plurality of quadrupoles configured as mass filters comprise a first quadrupole and a second quadrupole, the first quadrupole being defined by four electrodes driven by opposite polarity electrical signals having a first RF amplitude, and the second quadrupole being defined by four electrodes driven by opposite polarity electrical signals having a second RF amplitude, wherein the first quadrupole transmits ions with a first range of mass to charge values and the second quadrupole transmits ions with a second range of mass-to-charge values different than the first range, and
wherein the first and second quadrupoles share two electrodes whereby the first and second quadrupoles spatially overlap.

24. The parallel multi-beam mass spectrometer as defined in claim 23, wherein the two shared electrodes are segmented to permit application of two different RF signals to the same two shared electrodes.

25. The parallel multi-beam mass spectrometer as defined in claim 23, wherein the single multi-beam time-of-flight analyzer comprises a single position sensitive detector for simultaneously detecting the concurrent parallel beams of ions.

26. The parallel multi-beam mass spectrometer as defined in claim 23, wherein the single multi-beam time-of-flight analyzer comprises a plurality of individual detectors, each detector detecting a single beam of the concurrent parallel beams of ions.

27. The parallel multi-beam mass spectrometer as defined in claim 23, further comprising a collision cell communicating with at least one of the at least two of the plurality of quadrupoles configured as mass filters, the collision cell fragmenting the concurrent parallel beams of ions.

28. The parallel multi-beam mass spectrometer as defined in claim 23, wherein the single multi-beam time-of-flight analyzer further comprises a time-of-flight accelerator column for pulsing the concurrent parallel beams of ions into respective time of flight paths.

29. The parallel multi-beam mass spectrometer as defined in claim 23, wherein the single multi-beam time-of-flight analyzer further comprises a time-of-flight mirror for orthogonal reflection of the concurrent parallel beams of ions.

30. The parallel multi-beam mass spectrometer as defined in claim 23, wherein the first and second RF amplitudes of the RF and DC components of the electrical first and second RF signals are adjusted to attract and transmit different respective mass-to-charge ranges of ions.

31. The parallel multi-beam mass spectrometer as defined in claim 23, wherein the first and second RF signals are formed by square pulses.

32. The parallel multi-beam mass spectrometer as defined in claim 23, wherein the first and second RF signals each comprise a broadband excitation waveform designed to excite ions in all mass-to-charge ranges except those that are to be transmitted through the respective first and second quadrupoles.

33. A method for parallel multi-beam mass spectrometry comprising:
grouping electrodes defining a surface of an ion trap into a plurality of quadrupoles, the plurality of quadrupoles comprising a first quadrupole and a second quadrupole;
driving alternating electrodes of the first quadrupole with opposite polarity electrical signals having a first RF amplitude to form a first mass filter, the first mass filter transmitting ions with a first range of mass to charge values;
driving alternating electrodes of the second quadrupole with opposite polarity electrical signals having a second RF amplitude to form a second mass filter, the second mass filter transmitting ions with a second mass to charge values;
selectively ejecting concurrent parallel beams of ions from the first and second quadrupoles of the trap in predetermined ion mass-to-charge windows;
transmitting the concurrent parallel beams of ions to a single multi-beam time of flight analyzer; and
simultaneously detecting the concurrent parallel beams of ions with a position sensitive detector or a plurality of individual detectors,
wherein the first and second quadrupoles share two electrodes whereby both the first RF signal and the second RF signal are applied to the two shared electrodes.

34. The method as defined in claim 33, further comprising fragmenting the concurrent parallel beams of ions with at least one collision cell disposed between the ion trap and the time-of-flight analyzer.

35. The method as defined in claim 33, further comprising pulsing the concurrent parallel beams of ions into respective time of flight paths with the time-of-flight analyzer.

36. The method as defined in claim 33, further comprising orthogonally reflecting the concurrent parallel beams of ions with a time-of-flight mirror of the time-of-flight analyzer.

37. The method as defined in claim 33, wherein the two shared electrodes are segmented to permit application of both the first RF signal and the second RF signal.

38. The method as defined in claim 33, wherein the first and second RF amplitudes of the RF and DC components of the electrical first and second RF signals are adjusted to attract and transmit different respective mass-to-charge ranges of ions.

39. The method as defined in claim 33, wherein the first and second RF signals are formed by square pulses.

40. The method as defined in claim 33, wherein the first and second RF signals each comprise a broadband excitation waveform designed to excite ions in all mass-to-charge ranges except those that are to be transmitted through the respective first and second quadrupoles.
